(19) United States
(12) Patent Application Publication
(10) Pub. No.: US 2023/0367503 A1
(43) Pub. Date: Nov. 16, 2023

(54) COMPUTER SYSTEM AND STORAGE AREA ALLOCATION CONTROL METHOD

(71) Applicant: Hitachi, Ltd., Tokyo (JP)

(72) Inventors: Takayuki FUKATANI, Tokyo (JP); Mitsuo HAYASAKA, Tokyo (JP)

(73) Assignee: Hitachi, Ltd., Tokyo (JP)

(21) Appl. No.: 17/901,009

(22) Filed: Sep. 1, 2022

(30) Foreign Application Priority Data
May 12, 2022 (JP) 2022-079076

(51) Int. Cl. G06F 3/06; G06F 16/182

(52) U.S. Cl. CPC G06F 3/065; G06F 3/0619; G06F 3/0631; G06F 16/182

(57) ABSTRACT

Utilization efficiency of a storage device in a computer system can be appropriately improved. A computer system includes: a distributed FS including a plurality of distributed FS servers, the distributed FS being configured to distribute and manage files; a plurality of compute servers each having a processing function of executing a predetermined process using a PV provided by the distributed FS; and a management server configured to manage allocation of a PV to the compute servers. In the computer system, a processor of the management server is configured to determine whether data in the PV is protected due to redundancy by the plurality of compute servers, and allocate, as the PV of the plurality of compute servers, a PV in which data protection due to redundancy of data is not executed by the distributed FS from the distributed FS when determining that the data in the PV is protected.

### BACKGROUND OF THE INVENTION

### 1. Field of the Invention

The present invention relates to a technique for allocating a storage area that stores data to a processing function of a processing server that executes a predetermined process.

### 2. Description of the Related Art

A data lake for storing large capacity data for artificial intelligence (AI)/big data analysis is widely used.

In the data lake, a file storage, an object storage, a NoSQL/SQL database system, and the like are used, and operation is facilitated by containerizing the file storage, the object storage, the NoSQL/SQL database system, and the like. The term “container” as used herein refers to one of techniques for virtually building an operating environment for an application. In a container environment, a plurality of virtualized execution environments are provided on one operating system (OS), thereby reducing use resources such as a central processing unit (CPU) and a memory.

In the data lake, the NoSQL/SQL database system manages file data, and a distributed file system (distributed FS) capable of scaling out capacity and performance is widely used as a storage destination of the file data.

In the NoSQL/SQL database system and the distributed FS, data protection (data redundancy) is executed in each layer in order to achieve availability.

For example, as a technique for allocating a volume to a container, U.S. Pat. No. 9,678,683 specification (Patent Literature 1) discloses a technique in which a configuration management module automatically creates a persistent volume (PV) using an externally attached storage for an application container and allocates the persistent volume based on a container configuration definition created by a user.

For example, when the NoSQL/SQL database system is implemented as a container (referred to as a DB container), the DB container and data used in the DB container are made redundant among a plurality of servers for load distribution and high availability. In the distributed FS, for the high availability, data protection in which data is made redundant is executed in a plurality of distributed FS servers constituting the distributed FS.

For example, when data in files of the DB container is protected by the DB container and the data in the files of the DB is also protected by the distributed FS, the same data may be stored in storage areas more than necessary and utilization efficiency (capacity efficiency) of the storage area of a storage device may be reduced.

### SUMMARY OF THE INVENTION

The invention is made in view of the above circumstances, and an object thereof is to provide a technique capable of appropriately improving utilization efficiency of a storage area of a storage device in a computer system.

In order to achieve the above object, a computer system according to one viewpoint is a computer system including: a distributed file system including a plurality of file servers, the distributed file system being configured to distribute and manage files; a plurality of processing servers each having a processing function of executing a predetermined process using a storage area provided by the distributed file system; and a management device configured to manage allocation of a storage area to the processing servers, in which a processor of the management device is configured to determine whether data in the storage area is protected due to redundancy by the plurality of processing servers, and allocate, as the storage area of the plurality of processing servers, a storage area in which data protection due to redundancy of data is not executed by the distributed file system from the distributed file system when determining that the data in the storage area is protected.

According to the invention, utilization efficiency of the storage area of the storage device in the computer system can be appropriately improved.

### BRIEF DESCRIPTION OF THE DRAWINGS

FIG. 1 is a diagram illustrating an outline of a persistent volume allocation process to a DB container in a computer system according to a first embodiment.

FIG. 2 is an overall configuration diagram of the computer system according to the first embodiment.

FIG. 3 is a configuration diagram of a distributed FS server according to the first embodiment.

FIG. 4 is a configuration diagram of a compute server according to the first embodiment.

FIG. 5 is a configuration diagram of a management server according to the first embodiment.

FIG. 6 is a configuration diagram of a server management table according to the first embodiment.

FIG. 7 is a configuration diagram of a container management table according to the first embodiment.

FIG. 8 is a configuration diagram of a PV management table according to the first embodiment.

FIG. 9 is a configuration diagram of a data protection availability table according to the first embodiment.

FIG. 10 is a configuration diagram of a distributed FS control table according to the first embodiment.

FIG. 11 is a sequence diagram of a container creation process according to the first embodiment.

FIG. 12 is a flowchart of a data protection presence or absence determination process according to the first embodiment.

FIG. 13 is a flowchart of a PV creation and allocation process according to the first embodiment.

FIG. 14 is a flowchart of a distributed FS creation process according to the first embodiment.

FIG. 15 is a diagram illustrating an outline of a persistent volume allocation process to a DB container in a computer system according to a second embodiment.

FIG. 16 is an overall configuration diagram of the computer system according to the second embodiment.

FIG. 17 is a configuration diagram of a distributed FS server according to the second embodiment.

FIG. 18 is a configuration diagram of a block SDS server according to the second embodiment.

FIG. 19 is a configuration diagram of an external connection LU management table according to the second embodiment.

FIG. 20 is a configuration diagram of an LU management table according to the second embodiment.

FIG. 21 is a flowchart of a PV creation and allocation process according to the second embodiment.

FIG. 22 is a flowchart of an LU and distributed FS creation process according to the second embodiment.

FIG. 23 is a sequence diagram of a fail over process according to the second embodiment.

### DESCRIPTION OF THE PREFERRED EMBODIMENTS

Several embodiments will be described with reference to the drawings. The embodiments described below do not limit the invention according to the claims, and all elements and combinations thereof described in the embodiments are not necessarily essential to the solution of the invention.

In the following description, information may be described by an expression of “AAA table”, and the information may be expressed by any data structure. That is, in order to indicate that the information does not depend on the data structure, the “AAA table” may be referred to as “AAA information”.

In the following description, a process may be described using a “program” as a subject of an operation, while a program may be executed by a processor (for example, a CPU) to execute a predetermined process while appropriately using a storage unit (for example, a memory) and/or an interface (for example, a port), and thus the subject of the operation of the process may be the program. The process described using the program as the subject of the operation may be a process executed by a processor or a computer (for example, a server) including the processor. In addition, a hardware circuit that executes a part or all of the process to be executed by the processor may be provided. Alternatively, the program may be installed from a program source. The program source may be, for example, a program distribution server or a computer-readable (for example, non-transitory) recording medium. In the following description, two or more programs may be implemented as one program, or one program may be implemented as two or more programs.

### First Embodiment

First, an outline of a computer system 1 according to a first embodiment will be described.

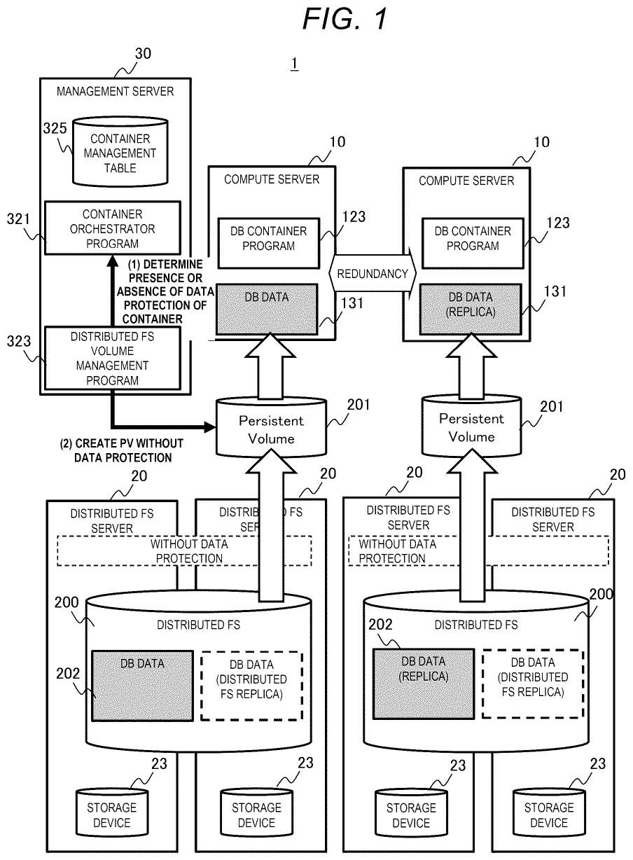

FIG. 1 is a diagram illustrating an outline of a persistent volume allocation process to a DB container in a computer system according to the first embodiment.

The computer system 1 includes a plurality of distributed file system (FS) servers 20, a plurality of compute servers 10, and a management server 30.

In the computer system 1, a DB container program 123 is activated on the plurality of compute servers 10 by a container orchestrator program 321 to create a DB container, and the DB container is made redundant. Therefore, DB data 131 managed by the DB container is managed by the plurality of compute servers 10 in a redundant manner. A distributed FS volume management program 323 of the management server 30 executes a process of allocating a persistent volume (PV) 201 that stores the DB data 131 used by the DB container program 123.

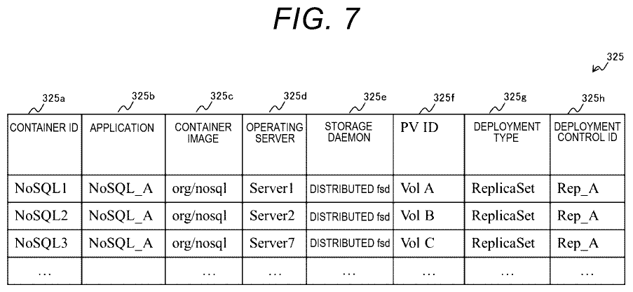

The distributed FS volume management program 323 acquires a container management table 325 (refer to FIG. 7) from the container orchestrator program 321 and determines whether the DB container program 123 is made redundant and the DB data 131 is protected ((1) in FIG. 1).

When the DB data of the DB container program 123 is protected, the distributed FS volume management program 323 creates a PV without data protection ((2) in FIG. 1), and allocates the PV to a DB container implemented by the DB container program 123.

Furthermore, when the PV 201 is created from a distributed FS 200 implemented by the plurality of distributed FS servers 20, in order to prevent the PV 201 allocated to each redundant DB container from being unavailable due to a single failure of the distributed FS server 20, in the present embodiment, the PV 201 allocated to each DB container is created from different distributed FSs 200 implemented by the different distributed FS servers 20. When such a distributed FS 200 is not present, a new distributed FS 200 is created, and a PV is created and allocated from the distributed FS 200.

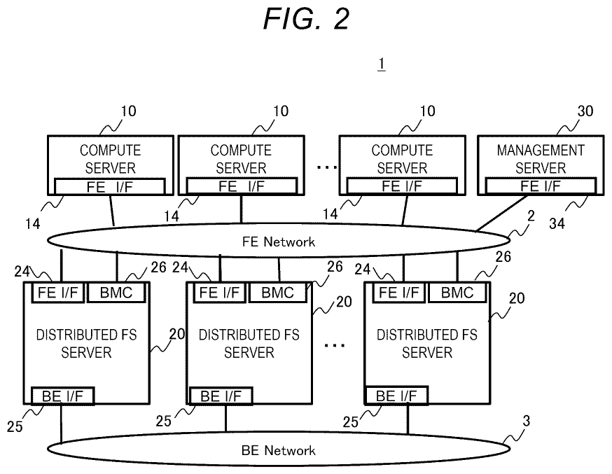

FIG. 2 is an overall configuration diagram of the computer system according to the first embodiment. The computer system 1 includes the compute servers 10 as an example of a plurality of processing servers, the distributed FS servers 20 as an example of a plurality of file servers, the management server 30 as an example of a management device, a front-end (FE) network 2, and a back-end (BE) network 3.

The management server 30, the compute servers 10, and the distributed FS servers 20 are connected via the FE network 2. The plurality of distributed FS servers 20 are connected via the BE network 3.

The compute server 10 is connected to the FE network 2 via an FE network I/F 14 (abbreviated as FE I/F in FIG. 2), executes a process of managing a NoSQL/SQL database system (DB system), and issues an I/O for a file (file I/O) including data (DB data) managed by the DB system to the distributed FS server 20. The compute server 10 executes the file I/O according to protocols such as network file system (NFS), server message block (SMB), and apple filing protocol (AFP). In addition, the compute server 10 may communicate with other devices for various purposes.

The management server 30 is a server for an administrator of the computer system 1 to manage the compute servers 10 and the distributed FS servers 20. The management server 30 is connected to the FE network 2 via an FE network I/F 34 and issues a management request to the compute servers 10 and the distributed FS servers 20. The management server 30 uses command execution via secure shell (SSH) or representational state transfer application program interface (REST API) as a communication form of the management request. The management server 30 provides the administrator with a management interface such as a command line interface (CLI), a graphical user interface (GUI), and the REST API.

The distributed FS server 20 implements a distributed FS that provides a volume (for example, persistent volume (PV)) which is a logical storage area for the compute server 10. The distributed FS server 20 is connected to the FE network 2 via an FE network I/F 24 and receives and processes the file I/O from the compute servers 10 and the management request from the management server 30. The distributed FS server 20 is connected to the BE network 3 via a BE network I/F (abbreviated as BE I/F in FIG. 2) 25 and communicates with another distributed FS server 20. The distributed FS server 20 exchanges metadata or exchanges other information with another distributed FS server 20 via the BE network 3. The distributed FS server 20 includes a baseboard management controller (BMC) 26, receives a power operation from an outside (for example, the management server 30 or the distributed FS server 20) at all times (including a time when a failure occurs), and processes the received power operation. The BMC 26 may use intelligent platform management interface (IPMI) as a communication protocol.

In the computer system 1 illustrated in FIG. 2, the FE network 2 and the BE network 3 are networks separated from each other, but the invention is not limited to this configuration. Alternatively, the FE network 2 and the BE network 3 may be implemented as the same network.

In the computer system 1 illustrated in FIG. 2, an example is illustrated in which the compute servers 10, the management server 30, and the distributed FS servers 20 are physically separate servers, but the invention is not limited to this configuration. Alternatively, for example, the compute servers 10 and the distributed FS servers 20 may be implemented by the same server, the management server 30 and the distributed FS servers 20 may be implemented by the same server, and the management server 30 and the compute servers 10 may be implemented by the same server.

Next, a configuration of the distributed FS server 20 will be described.

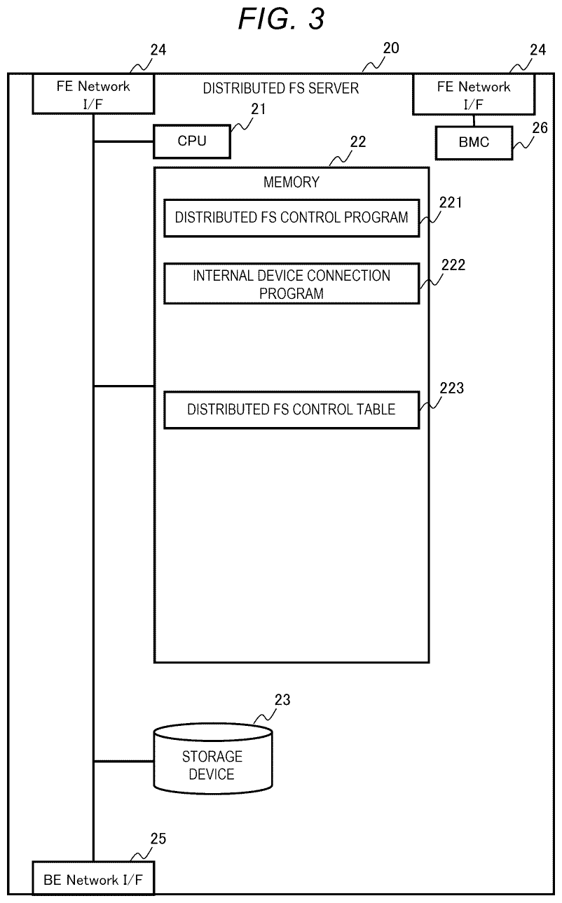

FIG. 3 is a configuration diagram of a distributed FS server according to the first embodiment.

The distributed FS server 20 is implemented by, for example, a bare metal server, and includes a CPU 21 as an example of a processor, a memory 22, a storage device 23, the FE network I/F 24, the BE network I/F 25, and the BMC 26.

The CPU 21 provides a predetermined function by processing according to programs on the memory 22.

The memory 22 is, for example, a random access memory (RAM), and stores programs to be executed by the CPU 21 and necessary information. The memory 22 stores a distributed FS control program 221, an internal device connection program 222, and a distributed FS control table 223.

The distributed FS control program 221 is executed by the CPU 21 to cooperate with the distributed FS control program 221 of another distributed FS server 20 and to constitute the distributed FS. In addition, the distributed FS control program 221 is executed by the CPU 21 to provide a persistent volume to the compute server 10.

The internal device connection program 222 is executed by the CPU 21 to read and write data from and to an internal device (storage device 23).

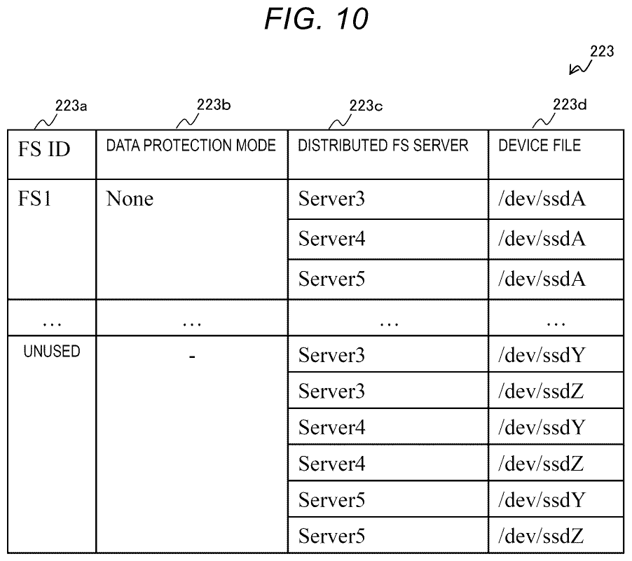

The distributed FS control table 223 is a table for managing information for controlling the distributed FS. The distributed FS control table 223 is synchronized so as to have the same contents in all of the distributed FS servers 20 constituting a cluster. Details of the distributed FS control table 223 will be described later with reference to FIG. 10.

The FE network I/F 24 is a communication interface device for connecting to the FE network 2. The BE network I/F 25 is a communication interface device for connecting to the BE network 3. The FE network I/F 24 and the BE network I/F 25 may be, for example, network interface cards (NIC) of Ethernet (registered trademark), or may be host channel adapters (HCA) of InfiniBand.

The BMC 26 is a device that provides a power supply control interface of the distributed FS server 20. The BMC 26 operates independently of the CPU 21 and the memory 22, and may receive a power supply control request from the outside to process power supply control even when a failure occurs in the CPU 21 or the memory 22.

The storage device 23 is a non-volatile storage medium that stores an OS, various programs, and data of files managed by the distributed FS that are used in the distributed FS server 20. The storage device 23 may be a hard disk drive (HDD), a solid state drive (SSD), or a non-volatile memory express SSD (NVMeSSD).

Next, a configuration of the compute server 10 will be described.

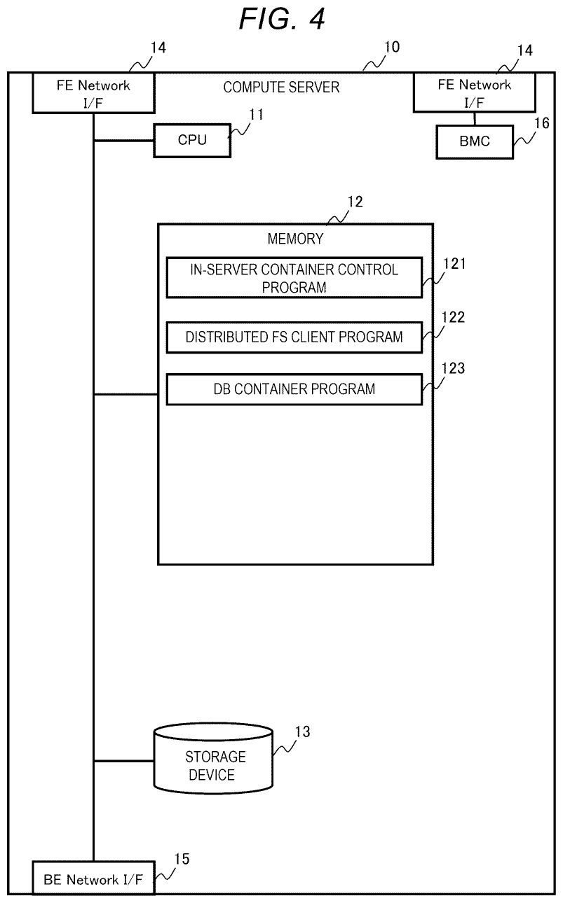

FIG. 4 is a configuration diagram of a compute server according to the first embodiment.

The compute server 10 includes a CPU 11 as an example of a processor, a memory 12, a storage device 13, the FE network I/F 14, a BE network I/F 15, and a BMC 16.

The CPU 11 provides a predetermined function by processing according to programs on the memory 12.

The memory 12 is, for example, a RAM, and stores programs to be executed by the CPU 11 and necessary information. The memory 12 stores an in-server container control program 121, a distributed FS client program 122, and the DB container program 123.

The in-server container control program 121 is executed by the CPU 11 to deploy or monitor container programs in the compute server according to an instruction of the container orchestrator program 321 of the management server 30, which will be described later. In the present embodiment, the in-server container control program 121 of each of the plurality of compute servers 10 and the container orchestrator program 321 cooperate with each other to implement a cluster which is an execution infrastructure of a container.

The distributed FS client program 122 is executed by the CPU 11 to connect to the distributed FS server 20 and to read and write data from and to the files of the distributed FS from a container of the compute server 10.

The DB container program 123 is executed by the CPU 11 to implement the container of the compute server 10 as the DB container and to operate a process for managing the DB. Here, a function implemented by the DB container is an example of a processing function.

The FE network I/F 14 is a communication interface device for connecting to the FE network 2. The BE network I/F 15 is a communication interface device for connecting to the BE network 3. The FE network I/F 14 and the BE network I/F 15 may be, for example, NIC of Ethernet (registered trademark), or may be HCA of InfiniBand.

The BMC 16 is a device that provides a power supply control interface of the compute server 10. The BMC 16 operates independently of the CPU 11 and the memory 12, and can receive a power supply control request from the outside and process power supply control even when a failure occurs in the CPU 11 or the memory 12.

The storage device 13 is a non-volatile storage medium that stores an OS, various programs, and data used in the compute server 10. The storage device 13 may be an HDD, an SSD, or an NVMeSSD.

Next, a configuration of the management server 30 will be described.

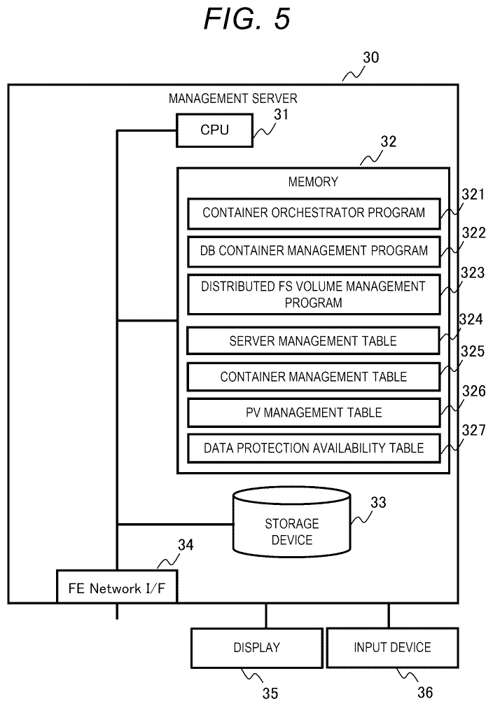

FIG. 5 is a configuration diagram of a management server according to the first embodiment.

The management server 30 includes a CPU 31 as an example of a processor, a memory 32, a storage device 33, and the FE network I/F 34. A display 35 and an input device 36 such as a mouse and a keyboard are connected to the management server 30.

The CPU 31 provides a predetermined function by processing according to programs on the memory 32.

The memory 32 is, for example, a RAM, and stores programs to be executed by the CPU 31 and necessary information. The memory 32 stores the container orchestrator program 321, a DB container management program 322, the distributed FS volume management program 323, a server management table 324, the container management table 325, a PV management table 326, and a data protection availability table 327.

The container orchestrator program 321 is executed by the CPU 31 to integrally manage containers in the plurality of compute servers 10. The container orchestrator program 321 controls deployment and undeployment and monitoring of the containers according to, for example, an instruction from the administrator. The container orchestrator program 321 controls each compute server 10 by instructing the in-server container control program 121, the DB container management program 322, and the distributed FS volume management program 323.

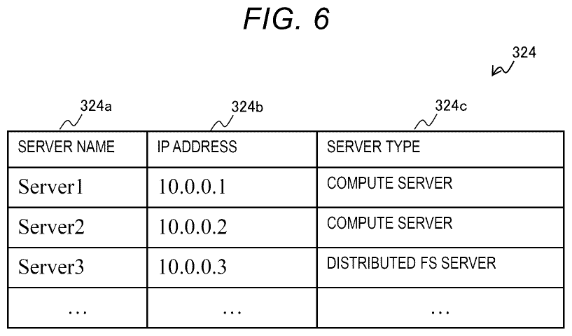

The DB container management program 322 executes deployment and undeployment on the DB container based on the instruction from the container orchestrator program 321. The distributed FS volume management program 323 allocates the PV to the container based on the instruction from the container orchestrator program 321. Here, the programs for allocating the PV are collectively referred to as a storage daemon. The server management table 324 is a table for storing information for the container orchestrator program 321 to manage the servers of the computer system 1. Details of the server management table 324 will be described later with reference to FIG. 6.

The container management table 325 is a table for storing information for the container orchestrator program 321 to manage containers implemented in the compute server 10. Details of the container management table 325 will be described later with reference to FIG. 7.

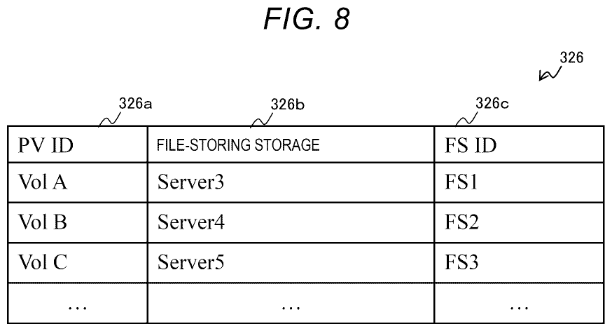

The PV management table 326 is a table for storing information for the distributed FS volume management program 323 to manage the PV. Details of the PV management table 326 will be described later with reference to FIG. 8.

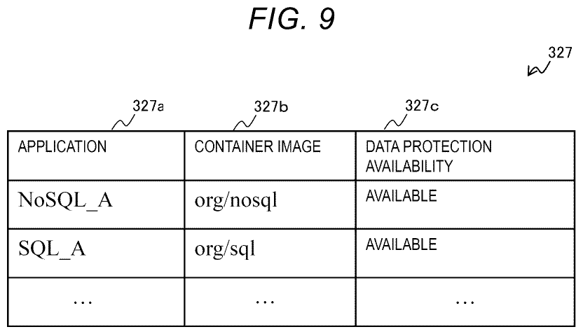

The data protection availability table 327 is a table for storing information for the distributed FS volume management program 323 to manage data protection availability of the containers. Details of the data protection availability table 327 will be described later with reference to FIG. 9.

The FE network I/F 34 is a communication interface device for connecting to the FE network 2. The FE network I/F 34 may be, for example, NIC of Ethernet (registered trademark), or may be HCA of InfiniBand.

The storage device 33 is a non-volatile storage medium that stores an OS, various programs, and data used in the management server 30. The storage device 33 may be an HDD, an SSD, or an NVMeSSD.

Next, a configuration of the server management table 324 will be described.

FIG. 6 is a configuration diagram of a server management table according to the first embodiment.

The server management table 324 stores management information for managing information of each server (the compute servers 10 and the distributed FS servers 20) in the computer system 1. The server management table 324 stores entries for each server. The entries of the server management table 324 include fields of a server name 324a, an IP address 324b, and a server type 324c.

The server name 324a stores information (for example, a server name) for identifying a server corresponding to the entry. Here, the server name is, for example, a network identifier (for example, a host name) for identifying a server corresponding to the entry in the FE network 2. The IP address 324b stores an IP address of the server corresponding to the entry. The server type 324c stores a type (server type) of the server corresponding to the entry. In the present embodiment, examples of the server type include a compute server and a distributed FS server.

Next, a configuration of the container management table 325 will be described.

FIG. 7 is a configuration diagram of a container management table according to the first embodiment.

The container management table 325 is a table for managing containers deployed in the compute server 10. The container management table 325 stores entries for each container. The entries of the container management table 325 include fields of a container ID 325a, an application 325b, a container image 325c, an operating server 325d, a storage daemon 325e, a PV ID 325f, a deployment type 325g, and a deployment control ID 325h.

The container ID 325a stores an identifier (container ID) of a container corresponding to the entry. The application 325b stores a type of an application that implements the container corresponding to the entry. Examples of the type of an application include a NoSQL, which is an application implementing a DB container of NoSQL, and an SQL, which is an application implementing a DB container of SQL. The container image 325c stores an identifier of an execution image of the container corresponding to the entry. The operating server 325d stores a server name of the compute server 10 on which the container corresponding to the entry operates. The operating server 325d may store an IP address of the compute server 10 instead of the server name.

The storage daemon 325e stores a name of a control program (storage daemon) for allocating a PV to the container corresponding to the entry. The PV ID 325f stores an identifier (PV ID) of a PV allocated to the container corresponding to the entry. The deployment type 325g stores a type (deployment type) of deployment of the container corresponding to the entry. Examples of the deployment type include None which allows a single compute server 10 to operate a container and a ReplicaSet which allows a set (ReplicaSet) of a plurality of servers to operate a container in a redundant manner. The deployment control ID 325h stores an identifier (deployment control ID) related to control for the container corresponding to the entry. Here, the containers deployed as the same ReplicaSet are associated with the same deployment control ID.

Next, a configuration of the PV management table 326 will be described.

FIG. 8 is a configuration diagram of a PV management table according to the first embodiment.

The PV management table 326 is a table for managing PVs. The PV management table 326 stores entries for each PV. The entries of the PV management table 326 include fields of a PV ID 326a, a file-storing storage 326b, and an FS ID 326c.

The PV ID 326a stores an identifier of a PV (PV ID) corresponding to the entry. The file-storing storage 326b stores a server name of the distributed FS server 20 that stores the PV corresponding to the entry. The file-storing storage 326b may store an IP address of the distributed FS server 20 instead of the server name. The FS ID 326c stores an identifier (FS ID) of the distributed FS that stores the PV corresponding to the entry.

Next, a configuration of the data protection availability table 327 will be described.

FIG. 9 is a configuration diagram of a data protection availability table according to the first embodiment.

The data protection availability table 327 is a table for managing information (feature information) on availability of data protection (data redundancy) for each application. A set value of the data protection availability table 327 may be registered in advance by the administrator. The data protection availability table 327 stores entries for each application. The entries of the data protection availability table 327 include fields of an application 327a, a container image 327b, and a data protection availability 327c.

The application 327a stores a type of an application corresponding to the entry. The container image 327b stores an identifier of an execution image of a container implemented by the application corresponding to the entry. The data protection availability 327c stores information on data protection availability (available and unavailable) indicating whether the data protection is available in the container implemented by the application corresponding to the entry. When the data protection is available in the data protection availability 327c, the data protection is actually executed when the ReplicaSet is implemented for the container implemented by this application.

Next, a configuration of the distributed FS control table 223 will be described.

FIG. 10 is a configuration diagram of a distributed FS control table according to the first embodiment.

The distributed FS control table 223 is a table that stores information for managing and controlling the distributed FS. The distributed FS control table 223 includes entries for each device (storage device) of the distributed FS server provided in the distributed FS. The entries of the distributed FS control table 223 include fields of an FS ID 223a, a data protection mode 223b, a distributed FS server 223c, and a device file 223d.

The FS ID 223a stores an identifier (FS ID) of a distributed FS implemented by a device corresponding to the entry. When the device corresponding to the entry does not implement the distributed FS, the FS ID 223a is set to “UNUSED”. The data protection mode 223b stores a data protection mode of an FS implemented by the device corresponding to the entry. Examples of the data protection mode include Replication in which data is protected by replica, Erasure Coding in which data is encoded and protected by a plurality of distributed FS servers, and None in which no data protection mode is adopted. The distributed FS server 223c stores a server name of the distributed FS server 20 including the device corresponding to the entry. The distributed FS server 223c may store an IP address of the distributed FS server 20 instead of the server name. The device file 223d stores a path of a device file, which is control information for accessing the device corresponding to the entry.

Next, processing of the computer system 1 according to the first embodiment will be described.

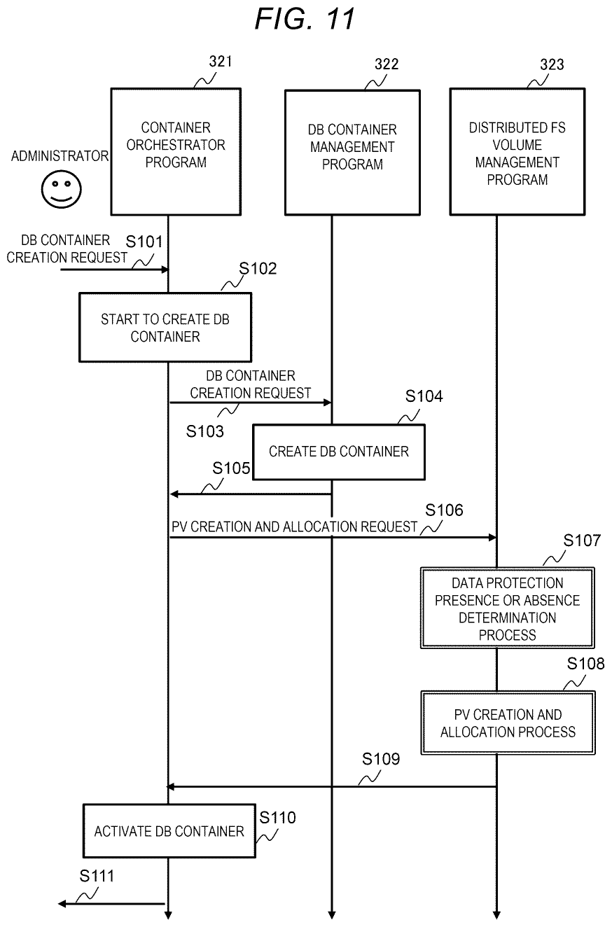

FIG. 11 is a sequence diagram of a container creation process according to the first embodiment.

When the container orchestrator program 321 (strictly speaking, the CPU 31 that executes the container orchestrator program 321) of the management server 30 receives a DB container creation request from the administrator (S101), the container orchestrator program 321 starts DB container creation (S102). Here, for example, the DB container creation request may be received from the administrator via an input device of the management server 30, or may be received from a terminal (not illustrated) of the administrator. In addition, the DB container creation request includes, as information on a DB container (target container) to be created, part of information (for example, the application, the container image, the storage daemon, and the deployment type) to be registered in the entries of the container management table 325, and a size of a PV to be allocated to the DB container.

When starting the DB container creation, the container orchestrator program 321 sends the DB container creation request to the DB container management program 322 to instruct the DB container management program 322 to create a DB container (S103).

When receiving the instruction to create the DB container, the DB container management program 322 instructs the in-server container control program 121 of the compute server 10 to create the DB container (S104), and returns a response indicating that the DB container is created to the container orchestrator program 321 (S105). When the DB container creation request includes designation of the ReplicaSet, the container orchestrator program 321 creates DB containers for the compute server 10 of the number of DB containers provided in the same ReplicaSet.

Next, the container orchestrator program 321 refers to a storage daemon (distributed FS volume management program) included in the DB container creation request, and transmits a PV creation and allocation request to the distributed FS volume management program 323 (S106). Here, the PV creation and allocation request includes a container ID of an allocation destination of the PV, a capacity of the PV, and the like. When the DB container creation request includes the designation of the ReplicaSet, the container orchestrator program 321 transmits the PV creation and allocation request for PVs of the number of the DB containers provided in the same ReplicaSet.

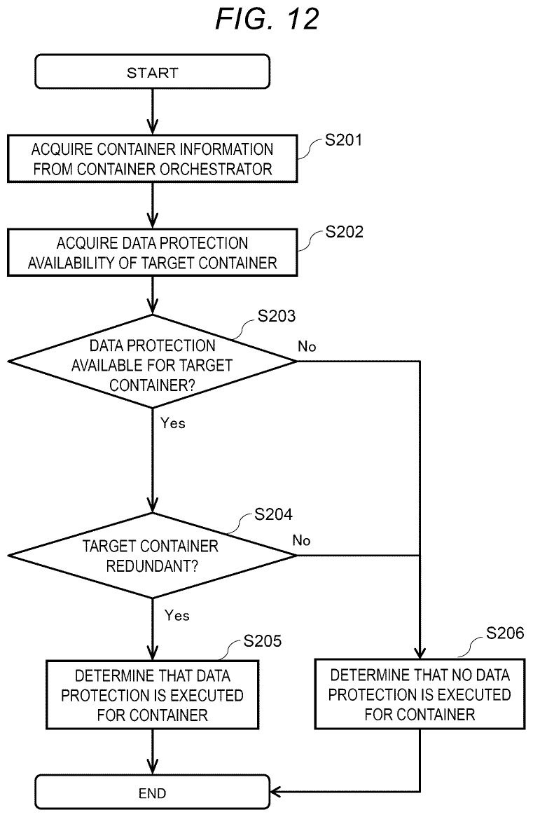

When receiving the PV creation and allocation request, the distributed FS volume management program 323 executes a data protection presence or absence determination process (refer to FIG. 12) of determining presence or absence of the data protection (redundancy) of the DB container of the allocation destination of the PV (S107).

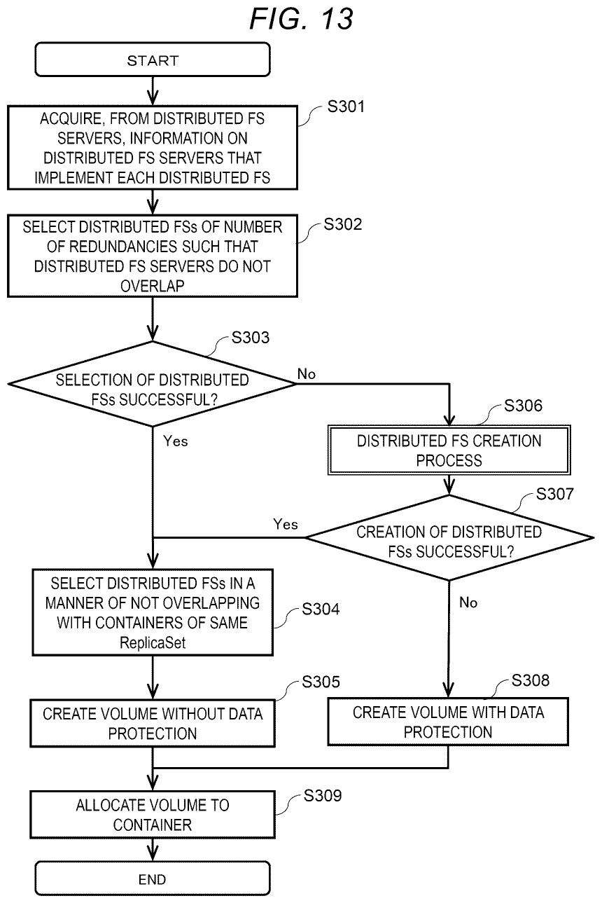

Next, when the data protection is present in the DB container of the allocation destination of the PV, the distributed FS volume management program 323 executes the PV creation and allocation process (refer to FIG. 13) of creating and allocating a PV to the DB container having the data protection (S108), and returns, to the container orchestrator program 321, a response indicating that the PV is allocated S109). When no data protection is present in the DB container of the allocation destination of the PV, the distributed FS volume management program 323 creates and allocates a PV having the data protection by the distributed FS to the DB container.

When receiving the response indicating that the PV is allocated, the container orchestrator program 321 activates the created DB container (S110), and returns a response indicating that the DB container is activated to a DB container creation request source (S111).

Next, the data protection presence or absence determination process in step S107 will be described.

FIG. 12 is a flowchart of the data protection presence or absence determination process according to the first embodiment.

First, the distributed FS volume management program 323 inquires of the container orchestrator program 321 to acquire information (the application type, an identifier of the container image, the deployment type, and the like) on the container (target container) of the allocation destination of the PV from the container management table 325 (S201).

Next, the distributed FS volume management program 323 uses the application type and the container image of the target container, which are acquired in step S201, refers to the data protection availability table 327, and acquires information on data protection availability of the target container (S202).

Next, the distributed FS volume management program 323 determines whether the data protection is available for the target container based on the information on the data protection availability acquired in step S202 (S203), and causes the process to proceed to step S204 when determining that the data protection is available for the target container (S203: Yes).

In step S204, the distributed FS volume management program 323 determines whether the target container is redundant, that is, whether the deployment type is the ReplicaSet.

As a result, when determining that the target container is redundant (S204: Yes), the distributed FS volume management program 323 determines that the data protection is executed for the target container (S205), and ends the process.

On the other hand, when determining that the data protection is not available for the target container in step S203 (S203: No), or when determining that the target container is not redundant (S204: No), the distributed FS volume management program 323 determines that no data protection is executed for the target container and ends the process.

Next, the PV creation and allocation process in step S108 will be described.

FIG. 13 is a flowchart of the PV creation and allocation process according to the first embodiment. The PV creation and allocation process is executed when it is determined that the data protection is present in the data protection presence or absence determination process.

The distributed FS volume management program 323 acquires, from the distributed FS servers 20, information (for example, the distributed FS control table 223) on the distributed FS servers 20 constituting the distributed FS (S301).

Next, the distributed FS volume management program 323 refers to the distributed FS control table 223 and selects distributed FSs without data protection (the data protection mode is None) of the number (number of redundancies) of redundant containers (containers to which the same deployment control ID is assigned) (S302). Specifically, the distributed FS volume management program 323 checks the distributed FS servers 20 constituting the distributed FS, and selects the distributed FSs of the number of redundancies such that the distributed FS servers 20 constituting the distributed FS do not overlap.

Next, the distributed FS volume management program 323 determines whether the selection of the distributed FSs of the number of redundancies is successful in step S302 (S303).

As a result, when determining that the selection of the distributed FSs of the number of redundancies is successful (S303: Yes), the distributed FS volume management program 323 inquires of the container orchestrator program 321, acquires the container management table 325 and the PV management table 326, refers to these tables to select the distributed FSs in a manner of not overlapping with the containers implementing the ReplicaSet implemented by containers to be allocated (S304), creates a PV without the data protection in the selected distributed FSs, registers entries of the created PV in the PV management table 326 (S305), and causes the process to proceed to step S309.

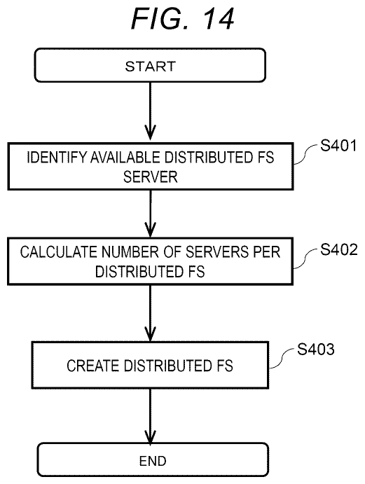

On the other hand, when determining that the selection of the distributed FSs of the number of redundancies is not successful (S303: No), the distributed FS volume management program 323 executes a distributed FS creation process (refer to FIG. 14) for creating new distributed FSs of the number of redundancies (S306).

Next, the distributed FS volume management program 323 determines whether the creation of the distributed FSs of the number of redundancies is successful (S307).

As a result, when determining that the creation of the distributed FSs of the number of redundancies is successful (S307: Yes), the distributed FS volume management program 323 causes the process to proceed to step S304.

On the other hand, when determining that the creation of the distributed FSs of the number of redundancies is not successful (S307: No), the distributed FS volume management program 323 creates a PV (the data protection mode is other than None) with the data protection to be allocated to each DB container, registers entries of the created PV in the PV management table 326 (S308), and causes the process to proceed to S309.

In step S309, the distributed FS volume management program 323 notifies the in-server container control program 121 of each compute server 10 that creates the DB container of information (PV ID, connection information, and the like) on the created PV, allocates the created PV to each container, registers the PV ID of the allocated PV in a record of each container of the container management table 325, and then ends the process.

Next, the distributed FS creation process in step S306 will be described.

FIG. 14 is a flowchart of the distributed FS creation process according to the first embodiment.

The distributed FS volume management program 323 acquires the distributed FS control table 223 from the distributed FS server 20, refers to the distributed FS control table 223, and identifies a distributed FS server 20 including an unused device as the available distributed FS server 20 (S401).

Next, the distributed FS volume management program 323 calculates the number of distributed FS servers per distributed FS by dividing the number of the available distributed FS servers 20 by the number of containers implementing the same ReplicaSet as the target container (S402).

Next, the distributed FS volume management program 323 instructs the distributed FS servers 20 to create distributed FSs implemented by the distributed FS servers 20 of the number of distributed FS servers calculated in step S402 by the number of structures of the ReplicaSet (S403). The distributed FS volume management program 323 creates the distributed FSs such that the distributed FS servers 20 constituting each distributed FS do not overlap.

As described above, in the present embodiment, the PV without the data protection is allocated to the DB container for protecting the data in a redundant manner. Accordingly, it is possible to appropriately prevent data protected in the DB container from being redundantly protected in the distributed FS, and it is possible to improve utilization efficiency of the storage area of the storage device.

### Second Embodiment

Next, an outline of a computer system 1A according to a second embodiment will be described. In the description of the second embodiment, the same components as those of the computer system 1 according to the first embodiment are denoted by the same reference numerals.

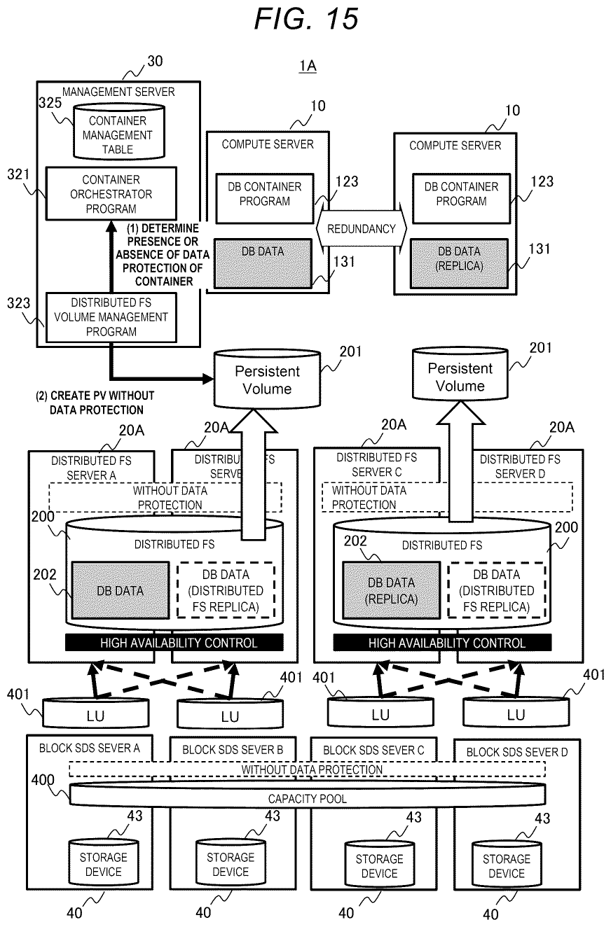

FIG. 15 is a diagram illustrating an outline of a persistent volume allocation process to a DB container in a computer system according to the second embodiment.

In the computer system 1A according to the second embodiment, data of a distributed FS of a distributed FS server is stored in a logical unit (LU) based on a capacity pool 400 that is provided by a block SDS cluster implemented by a plurality of block software defined storage (SDS) servers 40. In such a system, data redundancy can be executed in three layers including the DB container, the distributed FS, and a block SDS. In this case, capacity efficiency further deteriorates as compared with that according to the first embodiment.

The distributed FS 200 according to the present embodiment is, for example, a high availability configuration in which high availability control is executed by a plurality of distributed FS servers 20A. Here, the high availability control refers to that, when one distributed FS server 20A fails, another distributed FS server 20A executes control to continue a service.

In the present embodiment, the distributed FS volume management program 323 acquires the container management table 325 (refer to FIG. 7) from the container orchestrator program 321, and determines whether the DB container program 123 is redundant and the DB data 131 is protected ((1) in FIG. 15).

When the DB data of the DB container program 123 is protected, the distributed FS volume management program 323 creates a PV that is not protected by the distributed FS and that is also not protected by the block SDS ((2) in FIG. 15), and allocates the PV to a DB container implemented by the DB container program 123.

In the present embodiment, the distributed FS volume management program 323 selects the distributed FS 200 among PVs allocated to each DB container such that block SDS servers 40 providing storage areas do not overlap. When such a distributed FS 200 is not present, a new distributed FS 200 may be created.

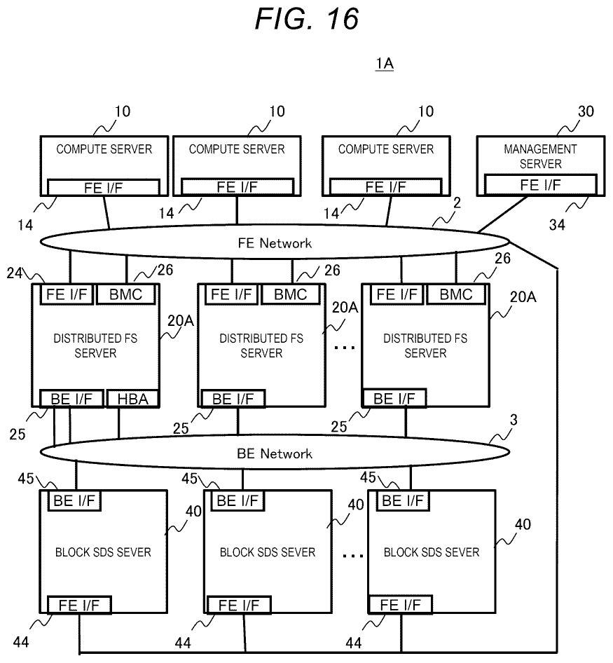

FIG. 16 is an overall configuration diagram of the computer system according to the second embodiment. In the second embodiment, the same configurations as those of the computer system 1 according to the first embodiment are denoted by the same reference numerals.

The computer system 1A includes the plurality of compute servers 10, the plurality of distributed FS servers 20A, a plurality of block SDS servers 40, the management server 30, the FE network 2, and the BE network 3.

The management server 30, the compute servers 10, the distributed FS servers 20A, and the block SDS servers 40 are connected via the FE network 2. The plurality of distributed FS servers 20A and the plurality of block SDS servers 40 are connected via the BE network 3.

The block SDS server 40 is an example of a block storage, and provides the logical unit (LU), which is a logical storage area, for the distributed FS server 20A. The block SDS server 40 is connected to the FE network 2 via an FE network I/F 44, and receives and processes a management request from the management server 30. The block SDS server 40 is connected to the BE network 3 via a BE network I/F 45, and communicates with the distributed FS server 20A or another block SDS server 40. The block SDS server 40 reads and writes data from and to the distributed FS server 20A via the BE network 3.

In the computer system 1A illustrated in FIG. 16, an example is illustrated in which the compute servers 10, the management server 30, the distributed FS servers 20A, and the block SDS servers 40 are physically separate servers, but the invention is not limited to this configuration. Alternatively, for example, the distributed FS servers 20A and the block SDS servers 40 may be implemented by the same server. Next, a configuration of the distributed FS server 20A will be described.

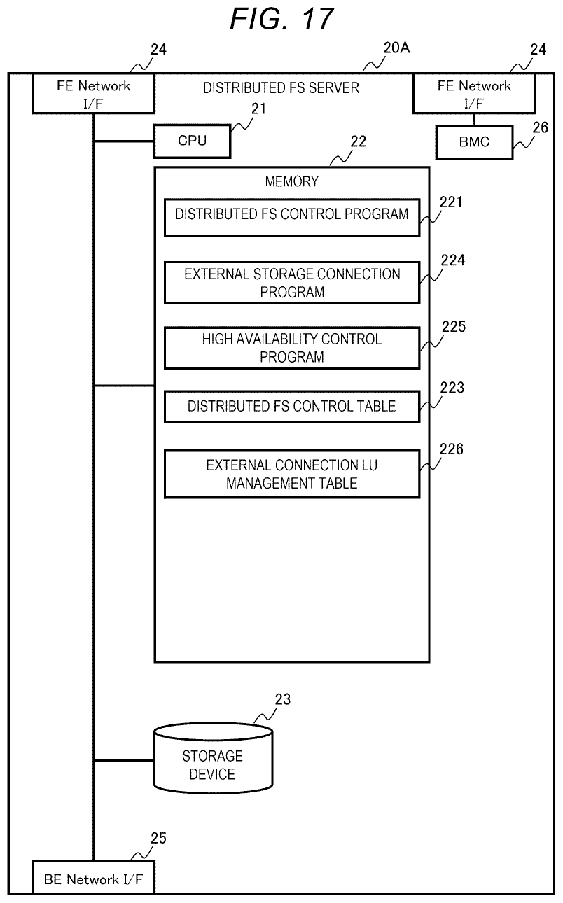

FIG. 17 is a configuration diagram of a distributed FS server according to the second embodiment.

The distributed FS server 20A further stores an external storage connection program 224, a high availability control program 225, and an external connection LU management table 226 in the memory 22 in the distributed FS server 20 according to the first embodiment.

The external storage connection program 224 is executed by the CPU 21 to access the LU provided by the block SDS server 40. The high availability control program 225 is executed by the CPU 21 to execute life-or-death monitor between the plurality of distributed FS servers 20A each having a high availability configuration, and to take over, when a failure occurs in one distributed FS server 20A, the process to another distributed FS server 20A.

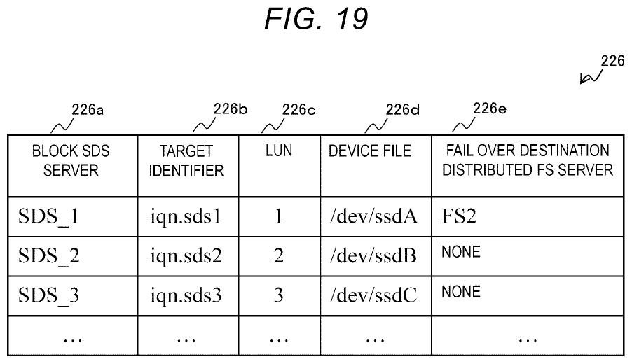

The external connection LU management table 226 is a table for managing the LU provided by the block SDS server 40 to which the distributed FS server 20A is connected. Details of the external connection LU management table 226 will be described later with reference to FIG. 19.

The BE network I/F 25 may be connected to the block SDS server 40 by, for example, iSCSI, fibre channel (FC), or NVMe over fablic (NVMe-oF).

Next, a configuration of the block SDS server 40 will be described.

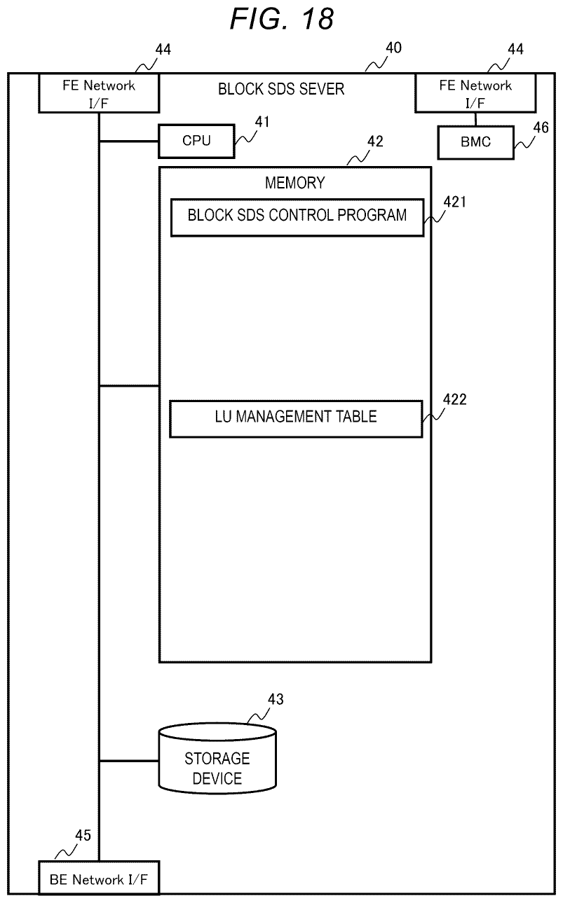

FIG. 18 is a configuration diagram of a block SDS server according to the second embodiment.

The block SDS server 40 includes a CPU 41 as an example of a processor, a memory 42, a storage device 43, the FE network I/F 44, the BE network I/F 45, and a BMC 46.

The CPU 41 provides a predetermined function by processing according to a program on the memory 42.

The memory 42 is, for example, a RAM, and stores programs to be executed by the CPU 41 and necessary information. The memory 42 stores a block SDS control program 421 and an LU management table 422.

The block SDS control program 421 is executed by the CPU 41 to provide the LU that can be read and written at a block level from and to an upper client (in the present embodiment, the distributed FS server 20A).

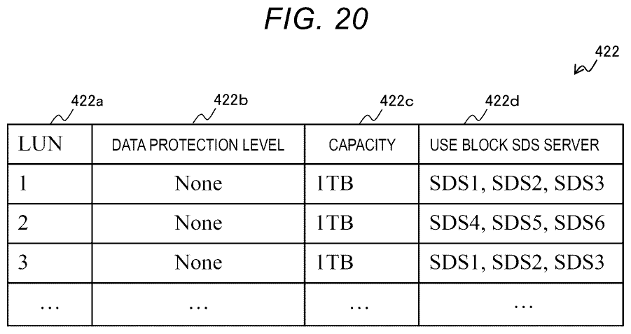

The LU management table 422 is a table for managing the LU. Details of the LU management table 422 will be described later with reference to FIG. 20.

The FE network I/F 44 is a communication interface device for connecting to the FE network 2. The BE network I/F 45 is a communication interface device for connecting to the BE network 3. The FE network I/F 44 and the BE network I/F 45 may be, for example, NIC of Ethernet (registered trademark), may be HCA of InfiniBand, or may correspond to iSCSI, FC, and NVMe-oF.

The BMC 46 is a device that provides a power supply control interface of the block SDS server 40. The BMC 46 operates independently of the CPU 41 and the memory 42, and may receive a power supply control request from the outside and process power supply control even when a failure occurs in the CPU 41 or the memory 42.

The storage device 43 is a non-volatile storage medium that stores an OS and various programs used in the block SDS server 40 and that stores data of the LU provided for the distributed FS. The storage device 43 may be an HDD, an SSD, or an NVMeSSD.

Next, a configuration of the external connection LU management table 226 will be described.

FIG. 19 is a configuration diagram of an external connection LU management table according to the second embodiment.

The external connection LU management table 226 stores information for managing the LU provided by the block SDS server 40 connected to the distributed FS server 20A. The external connection LU management table 226 stores entries for each LU. The entries of the external connection LU management table 226 include fields of a block SDS server 226a, a target identifier 226b, an LUN 226c, a device file 226d, and a fail over destination distributed FS server 226e.

The block SDS server 226a stores a server name of the block SDS server 40 that stores an LU corresponding to the entry. The block SDS server 226a may store an IP address of the block SDS server 40 instead of the server name. The target identifier 226b stores identification information (target identifier) of a port of the block SDS server 40 that stores the LU corresponding to the entry. The target identifier is used when the distributed FS server 20A establishes a session with the block SDS server 40. The LUN 226c stores an identifier (logical unit number (LUN)) in the block SDS cluster of the LU corresponding to the entry. The device file 226d stores a path of a device file for the LU corresponding to the entry. The fail over destination distributed FS server 226e stores a server name of the distributed FS server 20A of a fail over destination for the LU corresponding to the entry.

Next, a configuration of the LU management table 422 will be described.

FIG. 20 is a configuration diagram of an LU management table according to the second embodiment.

The LU management table 422 stores management information for managing LUs. The LU management table 422 stores entries for each LU. The entries of the LU management table 422 include fields of an LUN 422a, a data protection level 422b, a capacity 422c, and a use block SDS server 422d.

The LUN 422a stores an LUN of an LU corresponding to the entry. The data protection level 422b stores a data protection level of the LU corresponding to the entry. Examples of the data protection level include None indicating that no data protection is executed, Replication indicating that the data protection is executed by data replica, and Erasure Code indicating that the data protection is executed by erasure coding (EC). The capacity 422c stores a capacity of the LU corresponding to the entry. The use block SDS server 422d stores a server name of each of the block SDS servers 40 used in the storage area of the LU corresponding to the entry.

Next, a PV creation and allocation process according to the second embodiment will be described.

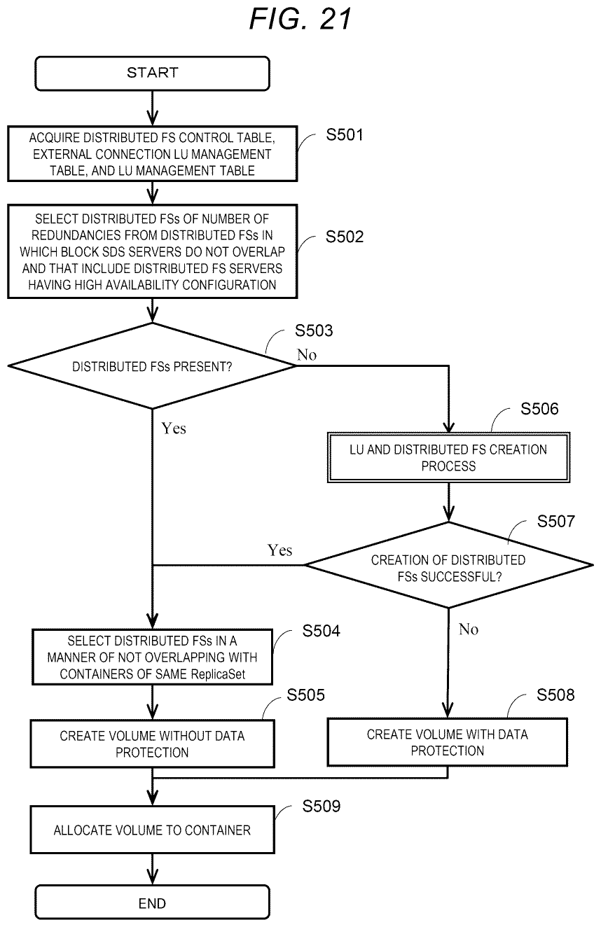

FIG. 21 is a flowchart of the PV creation and allocation process according to the second embodiment.

The PV creation and allocation process according to the second embodiment is a process executed instead of the PV creation and allocation process illustrated in FIG. 13.

The distributed FS volume management program 323 acquires the distributed FS control table 223 and the external connection LU management table 226 from the distributed FS server 20, and acquires the LU management table 422 from the block SDS server 40 (S501).

Next, the distributed FS volume management program 323 selects, by the number of redundancies, distributed FSs in which redundancy due to distributed FS is not executed, in which the data protection is not executed for LUs to be used, and in which the block SDS servers 40 to be used do not overlap (S502). Specifically, the distributed FS that is not made redundant by the distributed FS can be identified by referring to the distributed FS control table 223 and identifying that the data protection mode is None. In addition, the fact that data of an LU to be used in the identified distributed FS is not protected is identified by referring to the distributed FS control table 223 and identifying a device file of the distributed FS, referring to the external connection LU management table 226 and identifying a block SDS server and an LUN corresponding to the identified device file, and referring to the LU management table 422 of the identified block SDS server and identifying that a data protection level of the LU of the identified LUN is None. In addition, whether the block SDS servers 40 to be used in the distributed FS overlap may be identified by referring to use block SDS servers of the LU corresponding to each distributed FS of the LU management table 422.

Next, the distributed FS volume management program 323 determines whether the distributed FSs by the number of redundancies in step S502 are present (S503).

As a result, when determining that the distributed FSs by the number of redundancies are present (S503: Yes), the distributed FS volume management program 323 inquires of the container orchestrator program 321, acquires the container management table 325 and the PV management table 326, refers to these tables to select the distributed FSs in a manner of not overlapping with containers constituting a ReplicaSet including containers to be allocated (S504), creates a PV without the data protection in the selected distributed FSs, registers entries of the created PV in the PV management table 326 (S505), and causes the process to proceed to step S509.

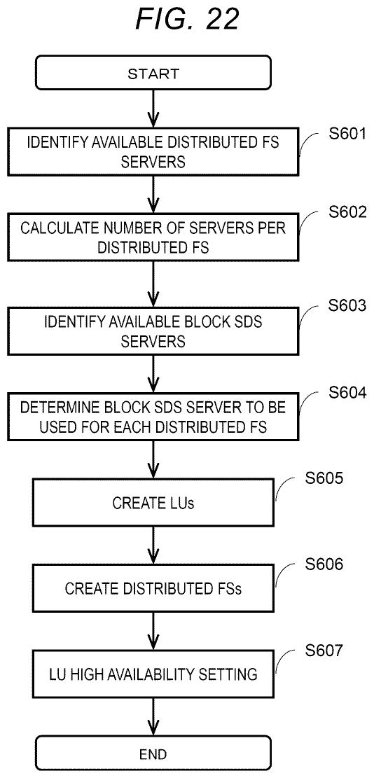

On the other hand, when determining that the distributed FSs by the number of redundancies are not present (S503: No), the distributed FS volume management program 323 executes an LU and distributed FS creation process (refer to FIG. 22) for creating new LUs and distributed FSs by the number of redundancies (S506).

Next, the distributed FS volume management program 323 determines whether the creation of the distributed FSs by the number of redundancies is successful (S507).

As a result, when determining that the creation of the distributed FSs by the number of redundancies is successful

(S507: Yes), the distributed FS volume management program 323 causes the process to proceed to step S504.

On the other hand, when determining that the creation of the distributed FSs by the number of redundancies is not successful (S507: No), the distributed FS volume management program 323 creates, in any distributed FS, a PV (the data protection mode is other than None) with the data protection to be allocated to each DB container, registers entries of the created PV in the PV management table 326 (S508), and causes the process to proceed to S509.

In step S509, the distributed FS volume management program 323 notifies the in-server container control program 121 of each compute server 10 that creates the DB container of information (PV ID, connection information, and the like) on the created PV, allocates the created PV to each container, registers the PV ID of the allocated PV in a record of each container of the container management table 325, and then ends the process.

According to this process, a PV implemented by an LU without data protection in a distributed FS without data protection is allocated to a DB container for protecting data in a redundant manner.

Accordingly, it is possible to appropriately prevent data protected in the DB container from being redundantly protected in the distributed FS or the block SDS server, and it is possible to improve utilization efficiency of the storage area of the storage device.

Next, the LU and distributed FS creation process according to the second embodiment will be described.

FIG. 22 is a flowchart of the LU and distributed FS creation process according to the second embodiment.

In the LU and distributed FS creation process, the distributed FS volume management program 323 creates distributed FSs by the number of containers provided in a

ReplicaSet including target blocks. Here, the created distributed FSs are without data protection and implemented using LUs without data protection.

First, the distributed FS volume management program 323 inquires of the container orchestrator program 321 to acquire the server management table 324, and refers to the server management table 324 to identify all the distributed FSs registered in the server management table 324 as available distributed FS servers (S601).

Next, the distributed FS volume management program 323 calculates the number of distributed FS servers per distributed FS by dividing the number of the available distributed FS servers 20 by the number of containers constituting a ReplicaSet of a target container (S602).

Next, the distributed FS volume management program 323 refers to the server management table 324 acquired in step S601 and identifies available block SDS servers 40 (S603).

Next, the distributed FS volume management program 323 determines the block SDS server 40 to be used for each created distributed FS (S604).

Next, the distributed FS volume management program 323 instructs the block SDS server 40 to use the block SDS server 40 determined in step S604, and creates LUs by the number of servers per distributed FS determined in step S602 for each distributed FS (S605).

Next, the distributed FS volume management program 323 connects the created LUs to the distributed FS server 20A, and creates a necessary number of distributed FSs (S606). At this time, the distributed FS volume management program 323 prevents the distributed FS servers and the block SDS servers that constitute the distributed FS from overlapping in each distributed FS.

Next, the distributed FS volume management program 323 selects the distributed FS servers 20A of the fail over destination of each created LU, sets the distributed FS server 20A to which the LU is connected and the selected distributed FS server 20A to high availability setting for executing high availability control (S607), and ends the process.

Next, a fail over process according to the second embodiment will be described.

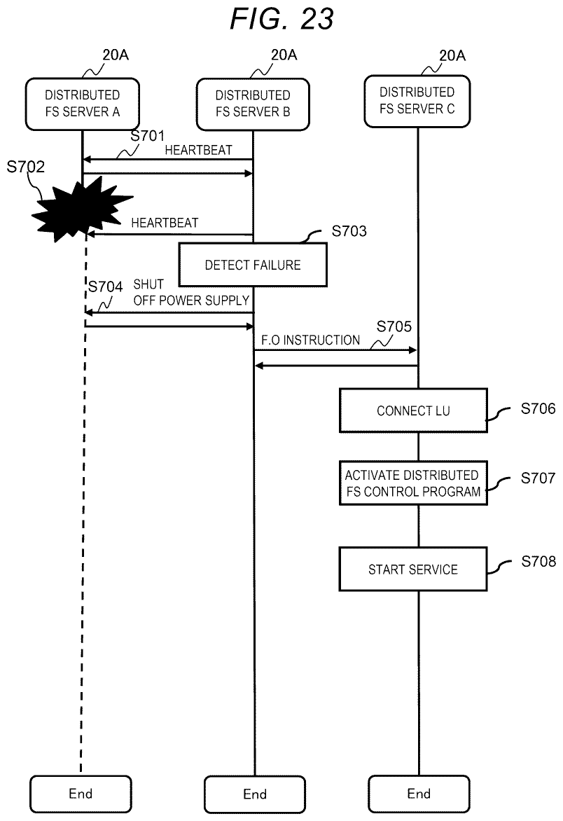

FIG. 23 is a sequence diagram of the fail over process according to the second embodiment.

The high availability control program 225 of the plurality of distributed FS servers 20A of the computer system 1A transmits and receives a heartbeat for executing life-or-death checking to and from the high availability control program 225 of another distributed FS server 40 (S701).

Here, in the distributed FS server 20A (a distributed FS server A in FIG. 23), when any failure occurs (S702), the high availability control program 225 of another distributed FS server 20A (a distributed FS server B in FIG. 23) detects that a failure occurred from the fact that the heartbeat from the distributed FS server A cannot be received (S703).

The high availability control program 225 of the distributed FS server B instructs the BMC 26 of the distributed FS server A in which the failure has occurred to shut off a power supply, and shuts off a power supply of the distributed FS server A (S704).

Next, the high availability control program 225 of the distributed FS server B transmits a fail over instruction to a distributed FS server C which is a fail over (F.0) destination of the distributed FS server A (S705).

The high availability control program 225 of the distributed FS server C that receives the fail over instruction connects the LU used in the distributed FS server A (S706), activates the distributed FS control program 221 to execute the fail over (S707), starts a process the same as a process executed by the distributed FS server A by the distributed FS control program 221 (S708), and ends the process.

The invention is not limited to the embodiments described above, and may be appropriately modified and implemented without departing from the gist of the invention.

For example, in the distributed FS creation process (FIG. 14) and the LU and distributed FS creation process (FIG. 22) according to the embodiments described above, the distributed FSs by the number of redundancies are created, but the invention is not limited thereto. Alternatively, distributed FSs of a number (insufficient number) that is not sufficient for the number of redundancies may be created.

In the embodiments described above, an example is illustrated in which a PV is allocated to a DB container that manages a DB, but the invention is not limited thereto, and may be applied, for example, when allocating a volume to a VM that manages a DB or to a process of managing a DB executed by a bare metal server.

In the embodiments described above, an example is illustrated in which the distributed FS server 20 is implemented by a bare metal server. Alternatively, the distributed FS server 20 may be implemented by a container or a virtual machine (VM).

In the embodiments described above, a part or all of the processes executed by the CPU may be executed by a hardware circuit. In addition, the programs in the embodiments described above may be installed from a program source. The program source may be a program distribution server or a recording medium (for example, a portable recording medium).

1. A computer system comprising:
a distributed file system including a plurality of file servers, the distributed file system being configured to distribute and manage files;
a plurality of processing servers each having a processing function of executing a predetermined process using a storage area provided by the distributed file system; and
a management device configured to manage allocation of a storage area to the processing servers, wherein
a processor of the management device is configured to
determine whether data in the storage area is protected due to redundancy by the plurality of processing servers, and
allocate, as the storage area of the plurality of processing servers, a storage area in which data protection due to redundancy of data is not executed by the distributed file system from the distributed file system when determining that the data in the storage area is protected.

2. The computer system according to claim 1, wherein
the management device is configured to store feature information on the data protection in the processing function of the processing server, and
the processor is configured to determine whether the data in the storage area is protected due to redundancy by the plurality of processing servers based on the feature information.

3. The computer system according to claim 1, wherein
the distributed file system includes a plurality of distributed file systems, and the plurality of distributed file systems are implemented by a set of the file servers that do not overlap,
the data protection is executed by making the processing function of the processing server redundant by the plurality of processing servers, and
the processor is configured to allocate a different storage area of the distributed file system to each of the plurality of processing servers having the redundant processing function.

4. The computer system according to claim 3, wherein
the processor is configured to create, when being not capable of allocating the different storage area of the distributed file system to the plurality of processing servers having the redundant processing function, a plurality of new distributed file systems that are implemented by a set of file servers not overlapping, and allocate the different storage area of the different distributed file system to the plurality of processing servers having the redundant processing function using storage areas of the created distributed file systems.

5. The computer system according to claim 4, wherein
the processor is configured to create the new distributed file systems by the number of file servers, the number being obtained by dividing the number of available file servers by the number of servers of the plurality of processing servers having the redundant processing function.

6. The computer system according to claim 1, further comprising:
a plurality of block storages that each provide a logical unit having a storage area for storing data at a block level to the distributed file system, wherein
the distributed file system provides, as the storage area, a storage area of the logical unit provided by the block storages.

7. The computer system according to claim 6, wherein
the distributed file system includes a plurality of distributed file systems,
the data protection is executed by making the processing function of the processing server redundant by the plurality of processing servers, and
the processor is configured to allocate a different storage area of the distributed file system provided by a different storage area of the block storage to the plurality of processing servers having the redundant processing function.

8. The computer system according to claim 7, wherein
the processor is configured to allocate, to the plurality of processing servers having the redundant processing function, a storage area of a different distributed file system, the distributed file system being provided by a different storage area of the block storage and being implemented such that, when a failure occurs in any of the file servers, another file system is capable of executing fail over.

9. The computer system according to claim 1, wherein
the processing function is implemented by a container or a virtual machine built on the processing server.

10. The computer system according to claim 1, wherein
the processing function is a function of managing the data by a database.

11. A storage area allocation control method executed by a computer system,
the computer system comprising:
a distributed file system including a plurality of file servers, the distributed file system being configured to distribute and manage files;
a plurality of processing servers each having a processing function of executing a predetermined process using a storage area provided by the distributed file system; and
a management device configured to manage allocation of a storage area to the processing servers,
the storage area allocation control method comprising:
determining, by the management device, whether data in the storage area is protected due to redundancy by the plurality of processing servers; and
allocating, by the management device, as the storage area of the plurality of processing servers, a storage area in which data protection due to redundancy of data is not executed by the distributed file system from the distributed file system when determining that the data in the storage area is protected.
